(19) United States
(12) Patent Application Publication
(10) Pub. No.: US 2017/0166138 A1
(43) Pub. Date: Jun. 15, 2017

(54) Clamp for Connecting Equipment onto the Bedrail of a Truck

(71) Applicant: Eric Anderson, Fountain Hills, AZ (US)

(72) Inventor: Eric Anderson, Fountain Hills, AZ (US)

(21) Appl. No.: 15/354,788

(22) Filed: Nov. 17, 2016

Related U.S. Application Data
(60) Provisional application No. 62/266,861, filed on Dec. 14, 2015.

(51) Int. Cl. B60R 9/02; E06C 5/00

(52) U.S. Cl. CPC B60R 9/02; E06C 5/00

(57) ABSTRACT

An apparatus that is used to attach a ladder to the bedrail of a pickup truck. The device has a support bracket, a clamp mechanism, and a slide rail. The support bracket clamps onto the bedrail of a truck. The clamp mechanism prevents an attached ladder from sliding out of the truck bed. The slide rail enables a user to reposition an attached ladder as desired. Thus secured, the ladder is prevented from displacement in any direction until the clamp is disengaged.

The current application claims a priority to the U.S. Provisional Patent application Ser. No. 62/266,861 filed on Dec. 14, 2015.

### FIELD OF THE INVENTION

The present invention relates generally to a connection mechanism used to retain a ladder in a desired position relative to a truck, more particularly to a device which clamps onto the bedrail of a pickup truck and latches onto the leg of a ladder, thus preventing the ladder form moving. A user of the present invention will be able to fixedly attach a ladder to the bed of a truck.

### BACKGROUND OF THE INVENTION

The field of construction employs the use of various tools. Because of the nature of construction, construction workers frequently have to pack up their tools and transport them to different construction sites. There are numerous enclosures used to store hand tools in the bed of a truck. Gang boxes and the like are frequently used when transporting small to medium sized tools. Additionally, it is possible to attach rails onto the bed of a truck for added storage. These rails enable a user to transport larger devices such as ladders, poles, and the like. However, one drawback to the use of rails is that additional devices must be employed to securely fasten any tools being transported. Additionally, these rails are more often than not permanent fixtures which add to the overall bulk of a truck.

The present invention addresses the above mentioned shortcomings by enabling a user to transport a ladder without the need to install rails, or employ bungie fastening devices. By integrating a clamp and a latching structure, the present invention is able to attach onto the existing bedrail of a truck. Thus attached, a user is able to quickly secure a ladder in a desired position. The present invention uses an adjustable clamp which enables a user to reposition the device as desired. Additionally, this adjustable clamp lets users remove the device when not in use. The present invention requires no permanent retrofit and enables a user to prevent a ladder from sliding out if the bed of a truck during transport.

### BRIEF DESCRIPTION OF THE DRAWINGS

FIG. 1 is a left-side view of the present invention.

FIG. 2 is a perspective view of the ladder bracket and the sleeve.

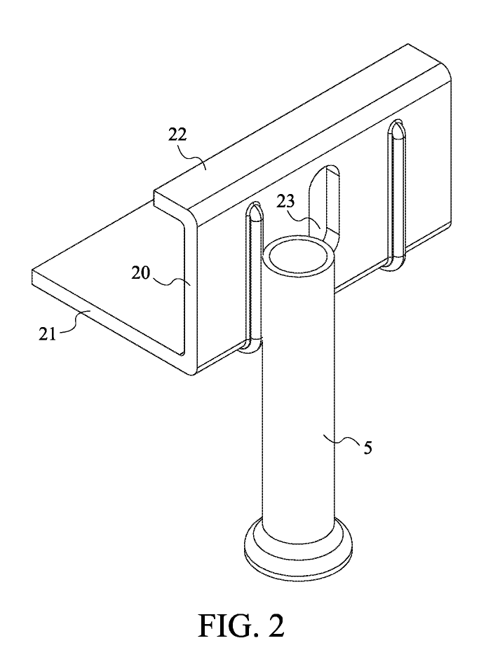

FIG. 3 is a perspective view of the leverage plate, the press plate, the stop bracket, the screw hole, and the textured surface.

FIG. 4 is a left-side view of the leverage plate, the press plate, the stop bracket, the screw hole, and the textured surface.

FIG. 5 is a left-side view of the present invention.

FIG. 6 is an exploded perspective view of the present invention.

### DETAIL DESCRIPTIONS OF THE INVENTION

All illustrations of the drawings are for the purpose of describing selected versions of the present invention and are not intended to limit the scope of the present invention.

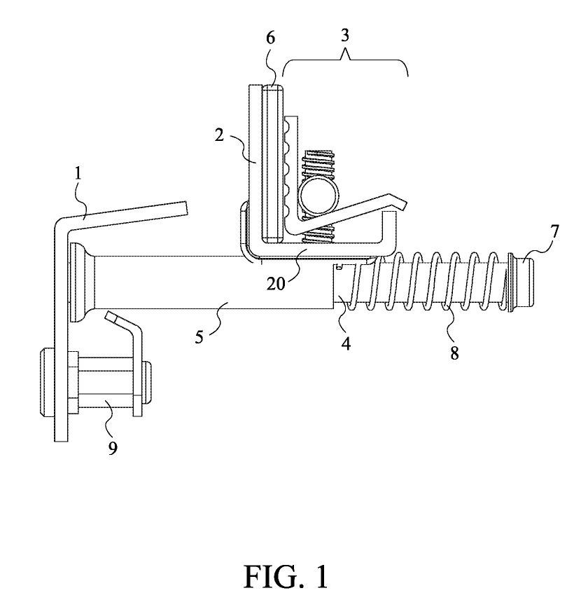

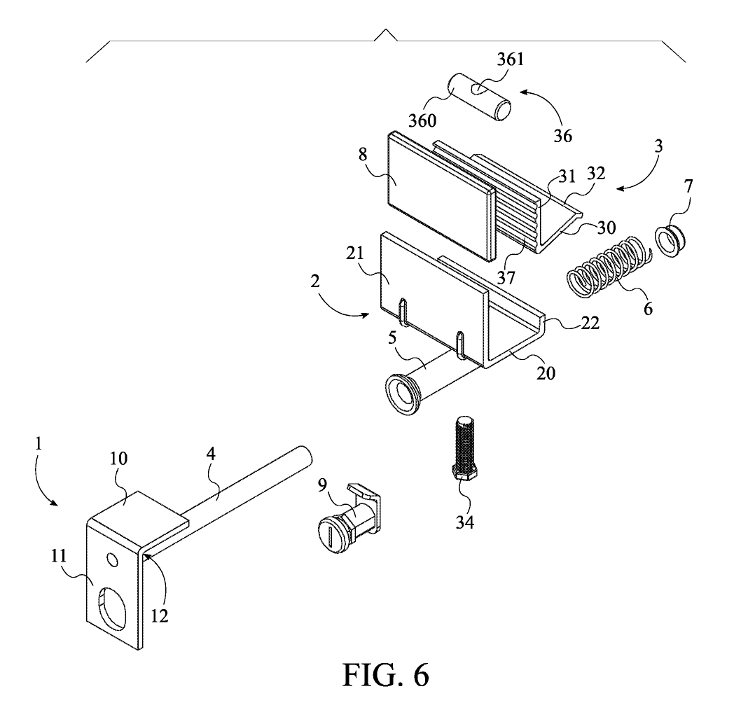

In reference to FIG. 1 and FIG. 6, the present invention is a clamp for attaching equipment onto the bedrail of a truck. In its preferred embodiment, the present invention is configured as a mechanical fastener that enables a user to detachably mount a ladder onto the bedrail of a traditional pickup truck. The present invention comprises a truck-bed bracket 1, a ladder bracket 2, a press mechanism 3, a rail 4, a sleeve 5, a compression spring 8, and a locking mechanism 9. The truck-bed bracket 1 is a rigid member with a first leg 10 and a second leg 11 that are connected at an angle to each other. As a result, the truck-bed bracket 1 is able to maintain the rail 4 in a desired position. A first end of the rail 4 is adjacently connected to the second leg 11 of the truck-bed bracket 1. As a result, the rail 4 is held in an orientation that is perpendicular to the bedrail of the truck to which the present invention is attached. A base 20 of the ladder bracket 2 is laterally connected to the sleeve 5 so that the sleeve 5 can mechanically support the ladder bracket 2. The rail 4 is telescopically engaged to the sleeve 5 so that the sleeve 5 can slide along the rail 4. Consequently, the truck-bed bracket 1 works in concert with the ladder bracket 2 and the rail 4 to brace the present invention against the bedrail of a truck. The press mechanism 3 is operatively mounted onto the base 20 of the ladder bracket 2, opposite the sleeve 5. Thus, the press mechanism 3 forms a clamp with the ladder bracket 2. The clamp formed by the ladder bracket 2 and the press mechanism 3 is used to attach a ladder to the present invention.

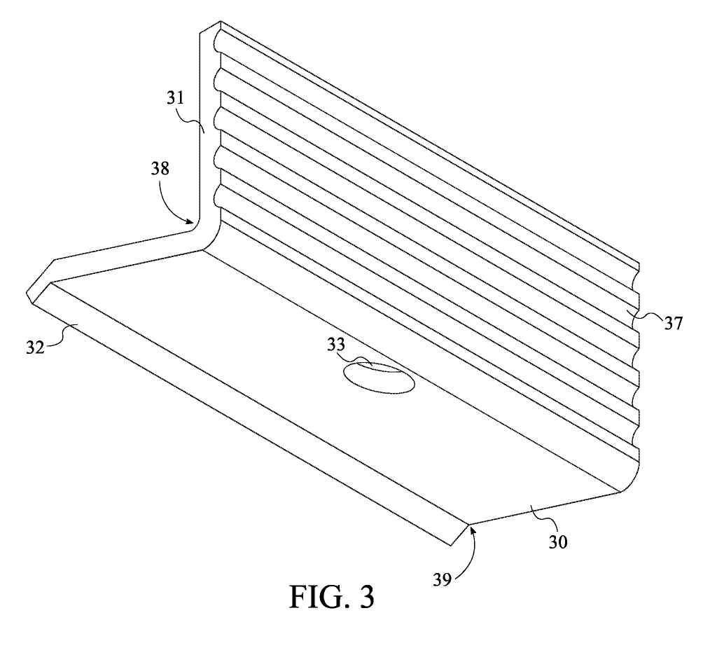

In reference to FIG. 1 and FIG. 3, in the preferred embodiment of the present invention, the ladder bracket 2 is the base component, against which the press mechanism 3 exerts force when clamping onto a ladder. In addition to the base 20, the ladder bracket 2 further comprises a ladder support 21, a press fulcrum 22, and a press slot 23. The ladder support 21 is a leg of the ladder bracket 2 that is perpendicularly and adjacently connected to the base 20 so that the ladder bracket 2 can be used to brace the present invention against the bedrail of a truck. The press fulcrum 22 is a separate leg of the ladder bracket 2 that is adjacently connected to the base 20, opposite the ladder support 21. As a result, the press mechanism 3 is able to use the press fulcrum 22 as a fulcrum point when being clamped onto a ladder. The press slot 23 traverses though the base 20 parallel to the ladder support 21. Furthermore, the press slot 23 is positioned along the sleeve 5 so that the press mechanism 3 can be slid along the press slot 23 and accommodate ladders of varying shape and size.

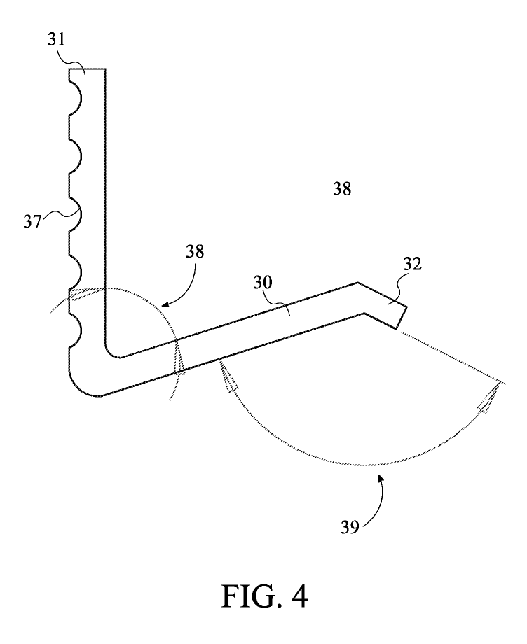

In reference to FIG. 3, FIG. 4, and FIG. 6, in the preferred embodiment of the present invention, the press mechanism 3 is a hand operated mechanical fastener that is used to clamp a ladder onto the ladder bracket 2. The press mechanism 3 comprises a leveraging plate 30, a press plate 31, a stop bracket 32, a screw hole 33, a screw 34, a fastener hole 35, and a nut 36. The press plate 31 is connected adjacent to the leveraging plate 30 at an acute angle 38 so that the press plate 31 can be forced against an attached ladder, while the press mechanism 3 is engaged. In the preferred embodiment of the present invention, the acute angle 38 is 72.37 degrees. The stop bracket 32 is connected adjacent to the leveraging plate 30, opposite the press plate 31, at an obtuse angle 39. In the preferred embodiment of the present invention the obtuse angle 39 is 135.86 degrees. The press fulcrum 22 of the ladder bracket 2 is slidably mounted to the leveraging plate 30. Consequently, the press mechanism 3 is prevented from sliding off the press fulcrum 22 by the stop bracket 32.

In reference to FIG. 3 and FIG. 6, in the preferred embodiment of the present invention, the nut 36 is a mechanical fastener that applies pressure to the leverage plate 30 and the press plate 31. As a result, the leverage plate 30 and the press plate 31 are forced toward the ladder bracket 2 by the nut 36. The nut 36 comprises a cylindrical body 360 and a female threaded hole 361. The fastener hole 35 traverses through the leveraging plate 30 in between the press plate 31 and the stop bracket 32 so that the screw 34 can pass through the leveraging plate 30 by moving through the fastener hole 35. The female threaded hole 361 laterally traverses through the cylindrical body 360 so that the screw 34 can engage the nut 36. The press plate 31 and leveraging plate 30 are tangentially pressed against the cylindrical body 360. The screw 34 traverses through the press slot 23 of the ladder bracket 2 and the fastener hole 35. The screw 34 is engaged to the female threaded hole 361. Consequently, tightening the screw 34 causes the cylindrical body 360 to exert force on the press plate 31 and the leveraging plate 30. Thus, engaging the press mechanism 3 and clamping onto a ladder. Conversely, loosening the screw 34 reduces the force exerted onto the press plate 31 and the leveraging plate 30. Thus, disengaging the press mechanism 3 and releasing the ladder. The textured surface 37 is superimposed onto the press plate 31 so that the press plate 31 can more securely clamp onto a ladder.

In reference to FIG. 1, in the preferred embodiment of the present invention, the compression spring 8 is a slidably engaged along the rail 4, in between the sleeve 5 and a second end of the rail 4. Consequently, the compression spring 8 applies force to the sleeve 5, moving the sleeve 5 towards the first end of the rail 4. In the preferred embodiment of the present invention, the compression spring 8 is a coiled spring. The coiled spring is telescopically engaged to the rail 4 so that the coiled spring can slide along the rail 4. A first end of the coiled spring being presses against the second end of the rail 4. A second end of the coiled spring is pressed against the sleeve 5. As a result, the coiled spring is able to apply a force onto the sleeve 5.

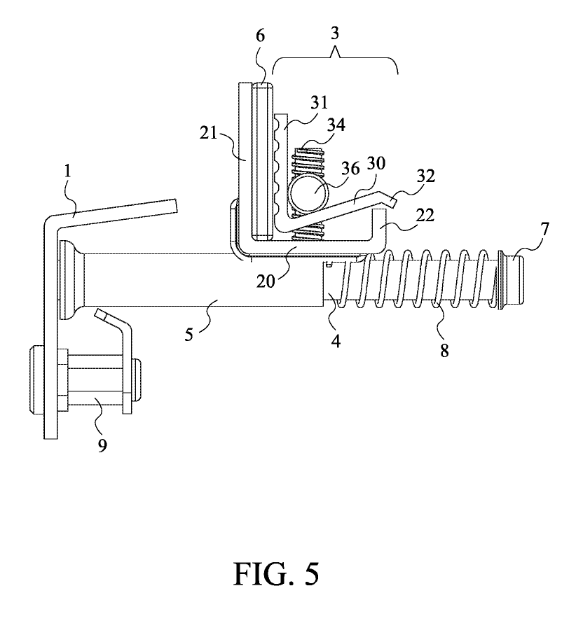

In reference to FIG. 5, the preferred embodiment of the present invention further comprises an end cap 7 that is adjacently connected to the second end of the rail 4, opposite the truck-bed bracket 1. This positioning enables the end cap 7 to prevent the compression spring 7 from sliding off the rail 4.

The present invention further comprises a compression pad 8, a ladder support 21, and a press plate 31. The compression pad 8 is a pliant piece of material that is detachably and adjacently connected to the ladder support 21. Furthermore, the compression pad 8 is positioned between the ladder support 21 and the press plate 31. As a result, the press plate 31 forces the body of an attached ladder into the compression pad 8 while the press mechanism 3 is engaged.

In reference to FIG. 1 and FIG. 6, in the preferred embodiment of the present invention, the locking mechanism 9 is mounted onto the second leg 11 of the truck-bed bracket 1. The locking mechanism 9 is mechanically coupled to the sleeve 5. Consequently, engaging the locking mechanism 9 restricts the rotary motion of the sleeve 5. Additionally, the locking mechanism 9 is equipped with a flared collar that comes into contact with the sleeve 5, while the locking mechanism 9 is engaged. This flared collar prevents the sleeve 5 from moving while the locking mechanism 9 is engaged.

Although the invention has been explained in relation to its preferred embodiment, it is to be understood that many other possible modifications and variations can be made without departing from the spirit and scope of the invention as hereinafter claimed.

What is claimed is:

1. A clamp for connecting equipment onto the bedrail of a truck comprises:
a truck-bed bracket;
a ladder bracket;
a press mechanism;
a rail;
a sleeve;
a first end of the rail being adjacently connected to the truck-bed bracket;
a base of ladder bracket being laterally connected to the sleeve;
the rail being telescopically engaged to the sleeve;
the press mechanism being operatively mounted onto the base, opposite the sleeve, wherein the press mechanism and the ladder bracket form a clamp;

2. The clamp for connecting equipment onto the bedrail of a truck as claimed in claim 1 comprises:
the ladder bracket further comprises a ladder support, a press fulcrum, and a press slot;
the ladder support being perpendicularly and adjacently connected to the base;
the press fulcrum being adjacently connected to the bracket body, opposite the ladder support;
the press slot traversing through the base parallel to the ladder support;
the press slot being positioned along the sleeve;

3. The clamp for connecting equipment onto the bedrail of a truck as claimed in claim 1 comprises:
the press mechanism comprises a leverage plate, a press plate, a stop bracket, and a screw hole;
the press plate being connected adjacent to the leveraging plate at an acute angle;
the stop bracket being connected adjacent to the leveraging plate, opposite to the press plate, at an obtuse angle;
a press fulcrum of the ladder bracket being slidably mounted to the leveraging plate;

4. The clamp for connecting equipment onto the bedrail of a truck as claimed in claim 3 comprises:
a screw;
a fastener hole;
a nut;
the nut comprises a cylindrical body and a female threaded hole;
the fastener hole traversing through the leveraging plate in between the press plate and the stop bracket;
the female threaded hole laterally traversing through the cylindrical body;
the press plate and the leveraging plate being tangentially pressed against the cylindrical body;
the screw traversing through a press slot of the ladder bracket and the fastener hole;
the screw being engaged to the female threaded hole;

5. The clamp for connecting equipment onto the bedrail of a truck as claimed in claim 3 comprises:
a textured surface;
the textured surface being superimposed onto the press plate.

6. The clamp for connecting equipment onto the bedrail of a truck as claimed in claim 3, wherein the acute angle is 72.37 degrees.

7. The clamp for connecting equipment onto the bedrail of a truck as claimed in claim 3, wherein the obtuse angle is 135.86 degrees.

8. The clamp for connecting equipment onto the bedrail of a truck as claimed in claim 1 comprises:
a compression spring;
the compression spring being slidably engaged along the rail in between the sleeve and a second end of the rail;

9. The clamp for connecting equipment onto the bedrail of a truck as claimed in claim 8 comprises:
the compression spring being a coiled spring;
the coiled spring being telescopically engaged to the rail;
a first end of the coiled spring being pressed against the second end of the rail;
a second end of the coiled spring being pressed against the sleeve;

10. The clamp for connecting equipment onto the bedrail of a truck as claimed in claim 1 comprises:
an end cap;
the end cap being adjacently connected to a second end of the rail, opposite the truck-bed bracket;

11. The clamp for connecting equipment onto the bedrail of a truck as claimed in claim 1 comprises:
a compression pad;
a ladder support;
a press plate;
the compression pad being detachably and adjacently connected to the ladder support;
the compression pad being positioned between the ladder support and the press plate;

12. The clamp for connecting equipment onto the bedrail of a truck as claimed in claim 1 comprises:
a locking mechanism;
the locking mechanism being mounted onto the truck bed bracket;
the locking mechanism being mechanically coupled to the sleeve, wherein engaging the locking mechanism restricts longitudinal and rotary motion of the sleeve;
